(19) United States
(12) Patent Application Publication
(10) Pub. No.: US 2025/0007805 A1
(43) Pub. Date: Jan. 2, 2025

(54) SYSTEMS AND METHODS FOR REAL-TIME QUALITY ANALYSIS OF WIRELESS LIVE AUDIO STREAMS

(71) Applicant: Mixhalo Corp., San Francisco, CA (US)

(72) Inventors: Carlos J. Morales Batista, Chicago, IL (US); Allison Kay Brecklin, Oakland, CA (US)

(21) Appl. No.: 18/760,469

(22) Filed: Jul. 1, 2024

Related U.S. Application Data
(60) Provisional application No. 63/524,498, filed on Jun. 30, 2023.

(51) Int. Cl. H04L 43/0852; G06F 3/16; H04L 65/61

(52) U.S. Cl. CPC H04L 43/0852; G06F 3/162; H04L 65/61

(57) ABSTRACT

A method for real-time detection of millisecond gaps in live audio streams includes receiving a data representation of a live audio signal corresponding to a live event via a wireless network and processing the data representation of the live audio signal corresponding to the live event into a live audio stream. The method also includes transmitting, by a first mobile computing device, the live audio stream to a second mobile computing device communicatively coupled to the first mobile computing device. The method also includes detecting a first gap in the received live audio stream and calculating at least one of a timestamp corresponding to the first gap in the received live audio stream or a duration of the first gap in the received live audio stream.

### RELATED APPLICATION(S)

This application claims priority to U.S. Provisional Patent Application No. 63/524,498, filed on Jun. 30, 2023, the entire disclosure of which is incorporated herein by reference.

### FIELD OF THE INVENTION

This invention relates generally to the field of real-time delivery of data, such as audio, over wireless networks. More specifically, the invention relates to systems and methods for real-time quality analysis of live audio streams delivered over wireless networks.

### BACKGROUND

Attendees of live events often bring and use their mobile computing device to stream data (e.g., audio or video) using at least one of the available wireless networks at the venue (e.g., Wi-Fi or cellular). Measuring and analyzing the quality of the streamed data is crucial in order to make any necessary adjustments to improve performance. For example, audio streams may suffer from buffer underrun events which produce gaps in audio. However, these types of audio gaps may be very small (e.g., a few milliseconds) and hard to detect using conventional systems and methods. Therefore, there is a need for systems and methods that can detect and measure audio gaps in a live audio stream.

### SUMMARY

The present invention includes systems and methods for real-time detection of millisecond gaps in live audio streams. For example, the present invention includes systems and methods for receiving a data representation of a live audio signal corresponding to a live event via a wireless network and processing the data representation of the live audio signal corresponding to the live event into a live audio stream. The present invention also includes systems and methods for transmitting the live audio stream from a first mobile computing device to a second mobile computing device communicatively coupled to the first mobile computing device. The present invention also includes systems and methods for detecting a gap in the received live audio stream and calculating at least one of a timestamp corresponding to the gap in the received live audio stream or a duration of the gap in the received live audio stream.

In one aspect, the invention includes a computerized method for real-time detection of millisecond gaps in live audio streams. The computerized method includes receiving, by a first mobile computing device, a data representation of a live audio signal corresponding to a live event via a wireless network. The computerized method also includes processing, by the first mobile computing device, the data representation of the live audio signal corresponding to the live event into a live audio stream. The computerized method also includes transmitting, by the first mobile computing device, the live audio stream to a second mobile computing device communicatively coupled to the first mobile computing device.

The computerized method also includes detecting, by the second mobile computing device, a first gap in the received live audio stream. The computerized method also includes calculating, by the second mobile computing device, at least one of a timestamp corresponding to the first gap in the received live audio stream or a duration of the first gap in the received live audio stream.

In some embodiments, the duration of the first gap in the received live audio stream is less than 20 milliseconds. For example, in some embodiments, the duration of the first gap in the received live audio stream is less than 10 milliseconds. In some embodiments, the duration of the first gap in the received live audio stream is less than 5 milliseconds.

In some embodiments, the computerized method further includes detecting, by the second mobile computing device, a second gap in the received live audio stream. For example, in some embodiments, the computerized method further includes calculating, by the second mobile computing device, at least one of a timestamp corresponding to the second gap in the received live audio stream or a duration of the second gap in the received live audio stream. In some embodiments, the computerized method further includes calculating, by the second mobile computing device, a rate of gaps corresponding to the received live audio stream.

In some embodiments, the first mobile computing device and the second mobile computing device are communicatively coupled via a wired connection. In other embodiments, the first mobile computing device and the second mobile computing device are communicatively coupled via a wireless connection.

In some embodiments, the computerized method further includes receiving, by the first mobile computing device, the data representation of the live audio signal corresponding to the live event from an audio server computing device via the wireless network.

In another aspect, the invention includes a system for real-time detection of millisecond gaps in live audio streams. The system includes a first mobile computing device communicatively coupled to a second mobile computing device. The first mobile computing device is configured to receive a data representation of a live audio signal corresponding to a live event via a wireless network. The first mobile computing device is also configured to process the data representation of the live audio signal corresponding to the live event into a live audio stream. The first mobile computing device is also configured to transmit the live audio stream to the second mobile computing device communicatively coupled to the first mobile computing device.

The second mobile computing device is configured to detect a first gap in the received live audio stream. The second mobile computing device is also configured to calculate at least one of a timestamp corresponding to the first gap in the received live audio stream or a duration of the first gap in the received live audio stream.

In some embodiments, the duration of the first gap in the received live audio stream is less than 20 milliseconds. For example, in some embodiments, the duration of the first gap in the received live audio stream is less than 10 milliseconds. In some embodiments, the duration of the first gap in the received live audio stream is less than 5 milliseconds.

In some embodiments, the second mobile computing device is also configured to detect a second gap in the received live audio stream. For example, in some embodiments, the second mobile computing device is also configured to calculate at least one of a timestamp corresponding to the second gap in the received live audio stream or a duration of the second gap in the received live audio stream. In some embodiments, the second mobile computing device is also configured to calculate a rate of gaps corresponding to the received live audio stream.

In some embodiments, the first mobile computing device and the second mobile computing device are communicatively coupled via a wired connection. In other embodiments, the first mobile computing device and the second mobile computing device are communicatively coupled via a wireless connection.

In some embodiments, the system includes an audio server computing device communicatively coupled to the first mobile computing device, the first mobile computing device configured to receive the data representation of the live audio signal corresponding to the live event from the audio server computing device via the wireless network.

These and other aspects of the invention will be more readily understood from the following descriptions of the invention, when taken in conjunction with the accompanying drawings and claims.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a schematic diagram of a system architecture for real-time delivery of live event data over wireless networks, according to an illustrative embodiment of the invention.

FIG. 2 is a schematic diagram of a system architecture for real-time detection of millisecond gaps in live audio streams, according to an illustrative embodiment of the invention.

FIGS. 3A-D are diagrams of exemplary audio samples analyzed using the system architecture of FIG. 2, according to an illustrative embodiment of the invention.

FIG. 4 is a schematic flow diagram illustrating real-time detection of millisecond gaps in live audio streams using the system architecture of FIG. 2, according to an illustrative embodiment of the invention.

### DETAILED DESCRIPTION

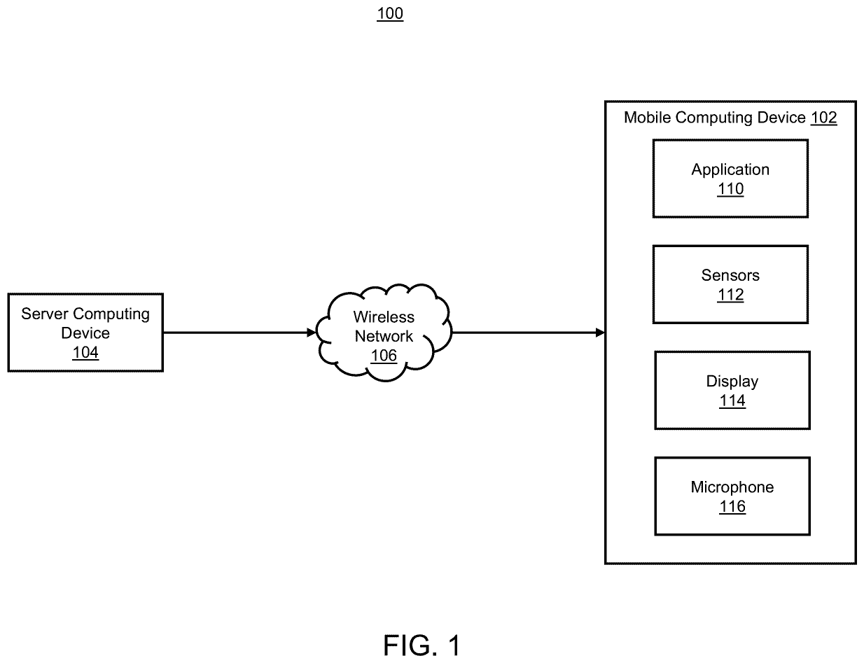

FIG. 1 is a schematic diagram of a system architecture 100 for real-time delivery of live event data over wireless networks, according to an illustrative embodiment of the invention. System 100 includes one or more mobile computing devices 102 communicatively coupled to a server computing device 104 (or audio server computing device) over one or more wireless networks 106. Mobile computing device 102 includes an application 110, one or more speakers 112, one or more displays 114, and one or more microphones 116. In some embodiments, the server computing device 104 is communicatively coupled to an audio interface (not shown).

Exemplary mobile computing devices 102 include, but are not limited to, tablets and smartphones, such as Apple® iPhone®, iPad® and other iOS®-based devices, and Samsung® Galaxy®, Galaxy Tab™ and other Android™-based devices. It should be appreciated that other types of computing devices capable of connecting to and/or interacting with the components of system 100 can be used without departing from the scope of invention. Although FIG. 1 depicts a single mobile computing device 102, it should be appreciated that system 100 can include a plurality of mobile computing devices.

Mobile computing device 102 is configured to receive a data representation of a live audio signal corresponding to the live event via wireless network 106. For example, in some embodiments, mobile computing device 102 is configured to receive the data representation of the live audio signal corresponding to the live event from server computing device 104 via wireless network 106, where server computing device 104 is coupled to an audio source at the live event (e.g., a soundboard that is capturing live audio). Mobile computing device 102 is also configured to process the data representation of the live audio signal into a live audio stream.

Mobile computing device 102 is also configured to initiate playback of the live audio stream via a first headphone (not shown) communicatively coupled to the mobile computing device 102 at the live event. For example, the user of mobile computing device 102 can connect a headphone to the device via a wired connection (e.g., by plugging the headphone into a jack on the mobile computing device) or via a wireless connection (e.g., pairing the headphone to the mobile computing device via a short-range communication protocol such as Bluetooth™). Mobile computing device 102 can then initiate playback of the live audio stream via the headphone.

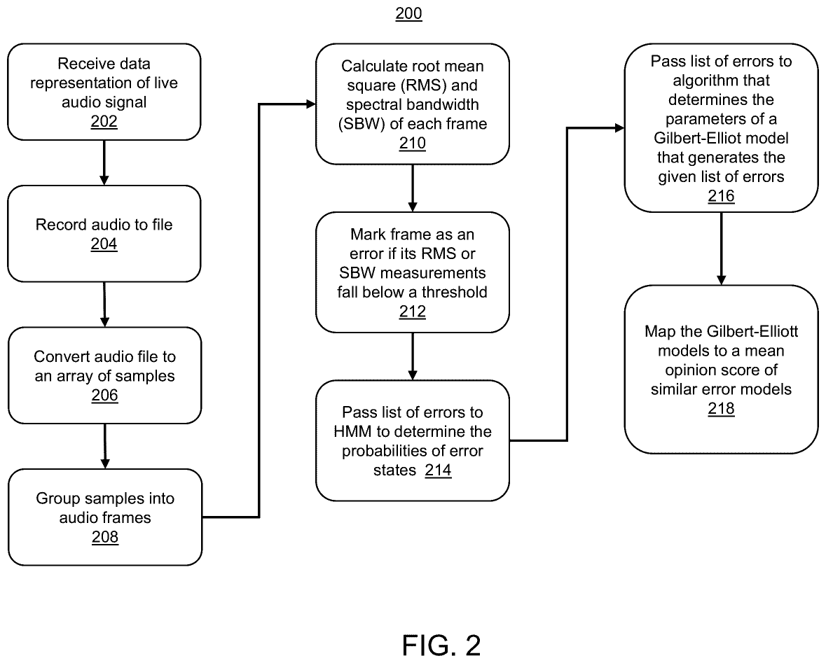

FIG. 2 is a flow diagram of a computerized method 200 of real-time detection of millisecond gaps in live audio streams, according to an illustrative embodiment of the invention. In some embodiments, the method 200 of FIG. 2 can be performed by system 100 of FIG. 1.

Mobile computing device 102 receives (step 202) a data representation of a live audio signal corresponding to the live event from server computing device 102 via wireless network 106. In some embodiments, application 110 of mobile computing device 102 is configured to activate a function to establish a connection to server computing device 104 via wireless network 106 in order to begin receiving the data representation of the live audio signal. An exemplary application 110 can be an app downloaded to and installed on the mobile computing device 102 via, e.g., the Apple® App Store or the Google® Play Store. A user of mobile computing device 102 can launch application 110 and interact with one or more user interface elements displayed by the application 110 on a screen of the mobile computing device 102 to start receiving the data representation of the live audio signal.

Mobile computing device 102 records (step 204) the data representation of the live audio signal to a file. In some embodiments, mobile computing device 102 can create an audio file in local memory and store at least a portion of the data representation of the live audio signal in the audio file. Exemplary file formats for storing the data representation of the live audio signal include, but are not limited to, WAV, MP3, OGG, FLAC, Apple® Lossless, and AAC. In some embodiments, mobile computing device 102 can store the data representation of the live audio signal in a temporary buffer location in memory.

Mobile computing device 102 converts (step 206) the audio file to an array of samples. In some embodiments, mobile computing device 102 converts the audio file into a NumPy array using one or more Python libraries/modules, such as PyAudio (available at people.csail.mit.edu/hubert/pyaudio), SciPy.io.wavefile (available in v.1.31.1 of scipy), or Pydub (available at pypi.org/project/pydub/).

Mobile computing device 102 groups (step 208) samples from the array of samples into audio frames. In some embodiments, mobile computing device 102 can determine a frame length of the audio frames based upon, e.g., a desired level of time resolution and/or accuracy. It should be appreciated that a low frame length improves time resolution by sacrificing accuracy. In some embodiments, frame length is measured in seconds or milliseconds.

Mobile computing device 102 calculates (step 210) the root mean square (RMS) and spectral bandwidth (SBW) of each audio frame. Generally, RMS is used to measure the average loudness of a waveform and SBW is used to measure the spread or width of frequencies present in an audio signal. In some embodiments, mobile computing device 102 uses the librosa.feature.rms function (in the librosa v0.10.2 Python package, available at librosa.org) to calculate the RMS for each audio frame. In some embodiments, mobile computing device 102 uses the librosa.feature.spectral_bandwidth function (also in the librosa v0.10.2 Python package) to calculate the SBW for each audio frame.

Mobile computing device 102 marks (step 212) an audio frame as an error if the RMS or SBW measurements for the audio frame (as calculated above) fall below a threshold value. In some embodiments, the RMS measurement for an audio frame can be below-30 dB-indicating that the frame is empty or received with an error. In some embodiments, the SBW measurement for an audio frame can be between 0 and 10 hZ-indicating that there is almost no spectral spread in the given frame and suggesting that the audio frame is empty or received with an error.

Mobile computing device 102 passes (step 214) the list of errors to a Hidden Markov Model (HMM) to determine the probabilities of error states. Generally, an HMM is a probabilistic model that consists of a sequence of hidden states (which are not directly observable), each of which generates an observation. The goal of the HMM is to estimate the sequence of hidden states based on a sequence of observations. In some embodiments, mobile computing device 102 uses the hmmlearn Python package (available at github.com/hmmlearn/hmmlearn) with the marked error audio frames as input to determine the probabilities that the error audio frames are indicative of a probable error state.

Mobile computing device 102 passes (step 216) the list of errors to an algorithm that determines the parameters of a Gilbert-Elliot model that generates the given list of errors. Generally, a Gilbert-Elliot model is a two-state model for describing errors in a digital communication link (as described in J. Pieper and S. Voran, “Relationships Between Gilbert-Elliot Burst Error Model Parameters and Error Statistics,” U.S. Dept. of Commerce NTIA Technical Memorandum 23-565, January 2023, which is incorporated herein by reference). In some embodiments, mobile computing device 102 uses the gilbert-elliot-model Python package (available at github.com/NTIA/gilbert-elliot-model) to estimate model parameters for a Gilbert-Elliot model.

Mobile computing device 102 maps (step 218) the Gilbert-Elliot models to a mean opinion score (MOS) of similar error models. In some embodiments, mobile computing device 102 maps the Gilbert-Elliot models to a MOS of similar error models in order to evaluate the overall quality of the streamed audio. Further detail regarding the process for mapping the Gilbert-Elliot models to a MOS is described in (i) G. Haßlinger and Oliver Hohlfeld, “The Gilbert-Elliot Model for Packet Loss in Real Time Services on the Internet,” Proceedings of the 14^{th} GI/ITG Conference on Measurement, Modelling and Evaluation of Computer and Communication Systems (MMB 2008), Mar. 31 to Apr. 2, 2008, Dortmund Germany, pp. 1-15; and (ii) O. Hohlfeld et al., “Packet Loss in Real-Time Services: Markovian Models Generating QoE Impairments,” 2008 16th International Workshop on Quality of Service, Enschede, Netherlands, 2008, pp. 239-248; each of which is incorporated herein by reference.

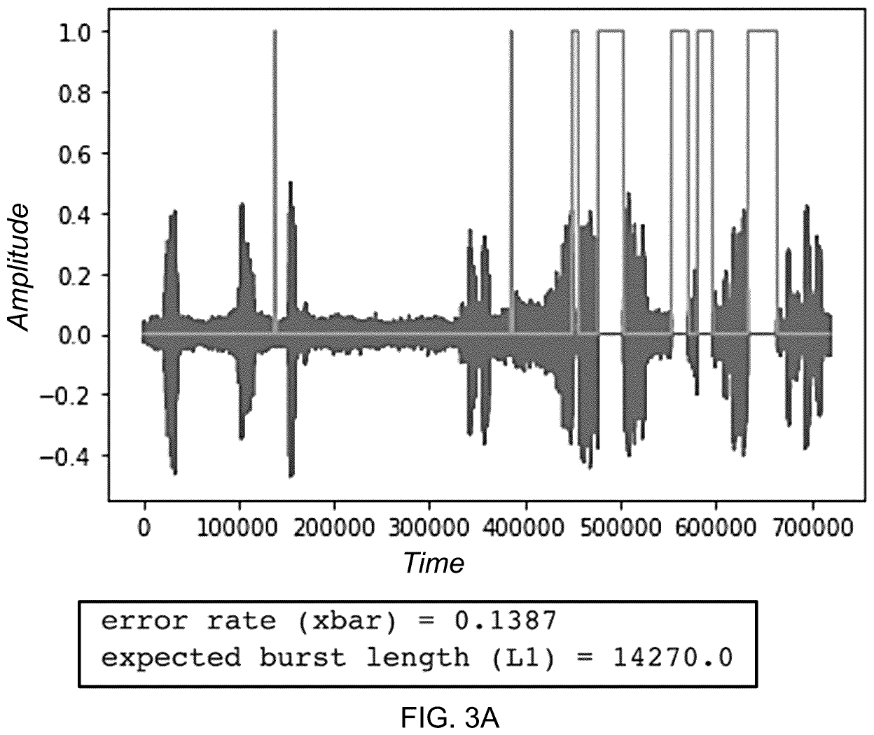

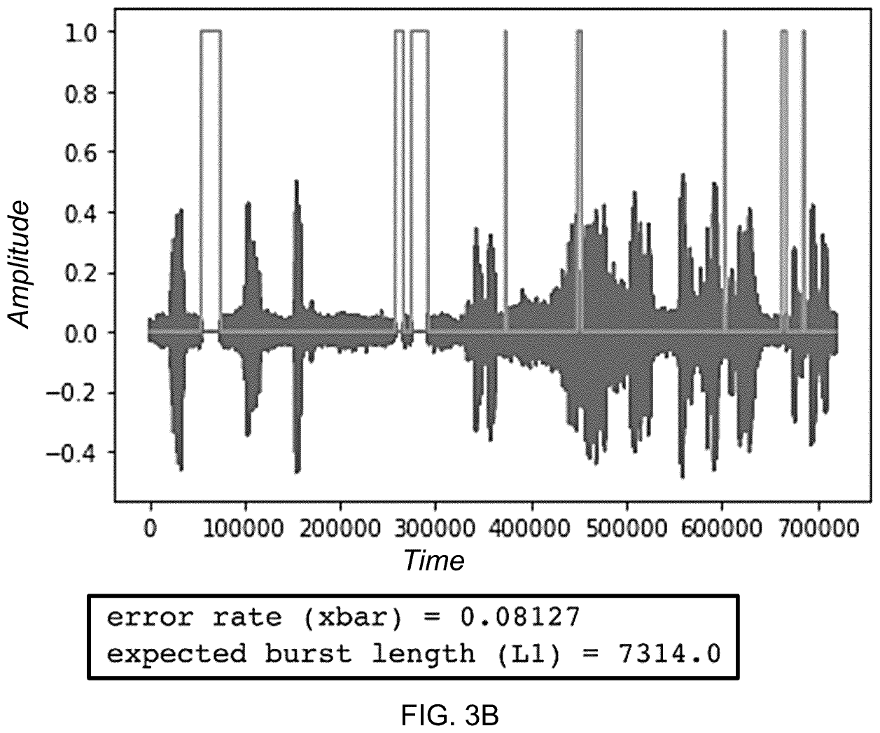

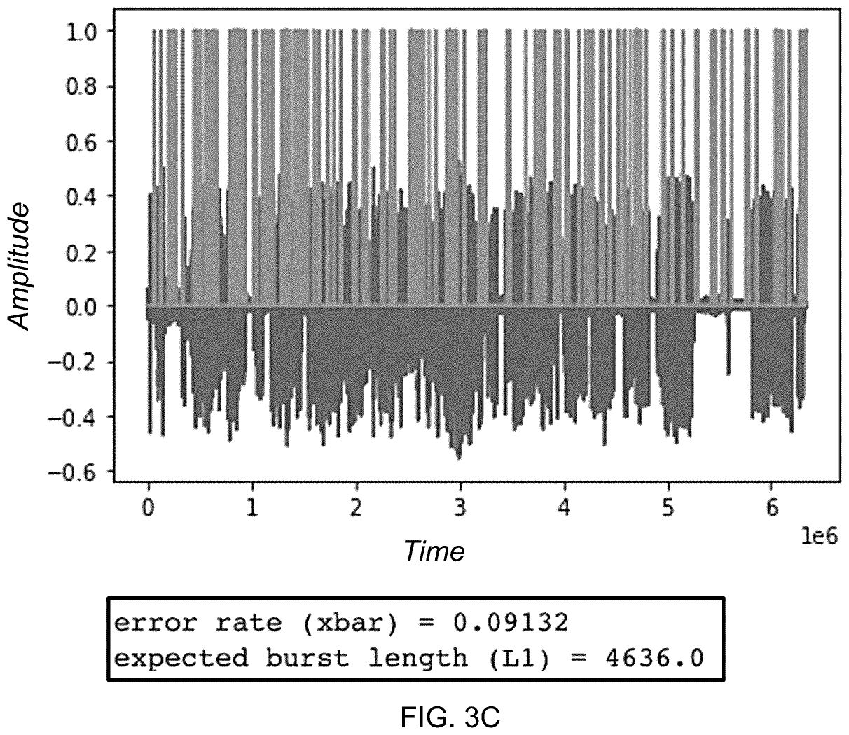

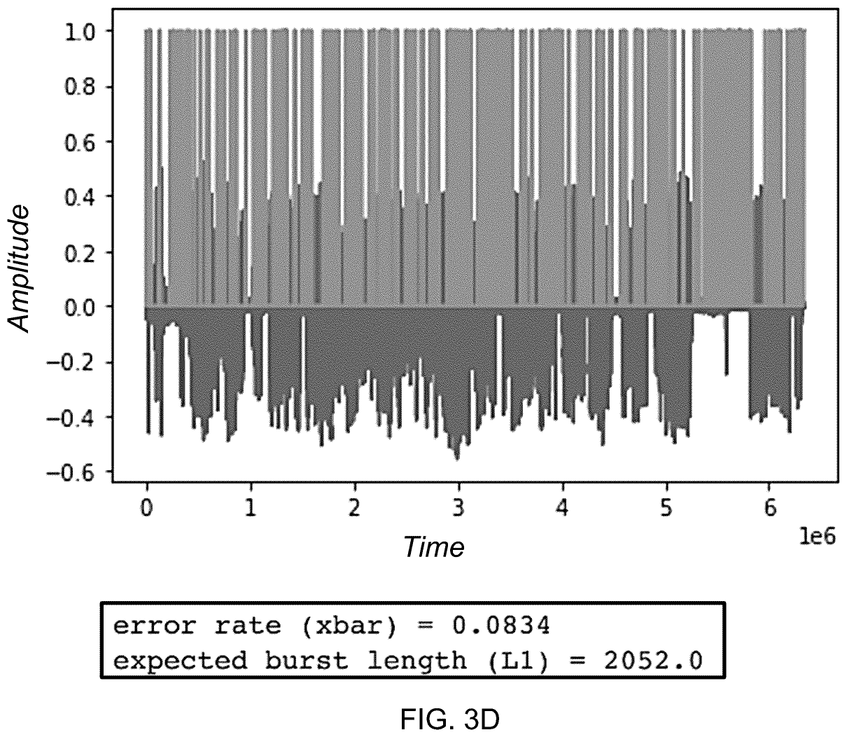

FIGS. 3A-D are diagrams of exemplary audio samples analyzed using system architecture 200, according to an illustrative embodiment of the invention. The exemplary audio sample is of a fifteen-second duration. Using system architecture 200, the Gilbert-Elliot model was applied using different error rates, and expected burst duration, to the original audio sample. The audio and errors are visualized under the audio clip. Because the Gilbert-Elliot model is stochastic, the specified error parameters do not always yield the desired error pattern so the actual error statistics are printed out under each graph for transparency. For example, FIG. 3A illustrates exemplary audio with approximately 10% loss at 300 ms (14400 samples) burst duration. FIG. 3B illustrates exemplary audio with approximately 10% loss at 200 ms (9600 samples) burst duration. FIG. 3C illustrates exemplary audio with approximately 10% loss at 100 ms (4800 samples) burst duration. FIG. 3D illustrates exemplary audio with approximately 10% loss at 50 ms (2400 samples) burst duration.

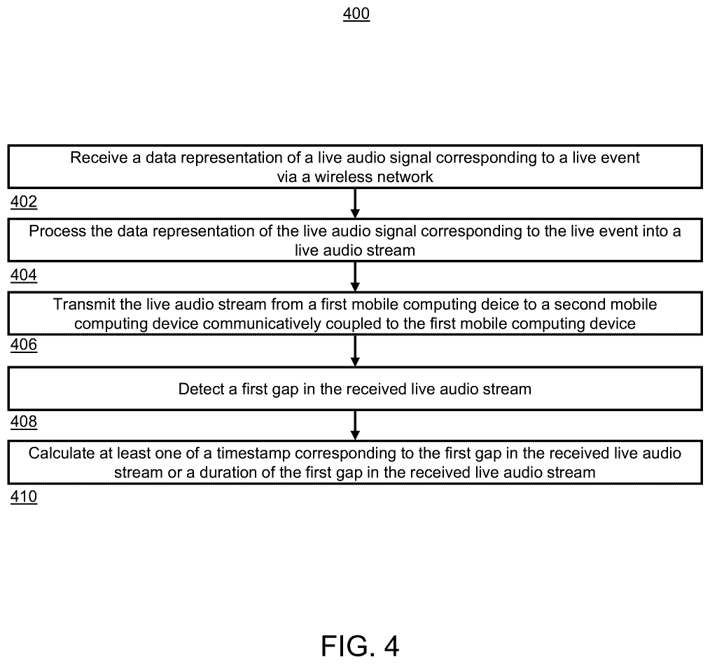

FIG. 4 is a schematic flow diagram of a process 400 for real-time detection of millisecond gaps in live audio streams using system architecture 200, according to an illustrative embodiment of the invention. Process 400 begins by receiving, by a first mobile computing device 102, a data representation of a live audio signal corresponding to a live event via a wireless network 106 at step 402. In some embodiments, process 400 begins by receiving, by the first mobile computing device 102, the data representation of the live audio signal corresponding to the live event from an audio server computing device 104 via the wireless network 106. Process 400 continues by processing, by the first mobile computing device 102, the data representation of the live audio signal corresponding to the live event into a live audio stream at step 404.

Process 400 continues by transmitting, by the first mobile computing device 102, the live audio stream to a second mobile computing device 102 communicatively coupled to the first mobile computing device 102 at step 406. For example, in some embodiments, the first mobile computing device 102 and the second mobile computing device 102 are communicatively coupled via a wired connection. In other embodiments, the first mobile computing device 102 and the second mobile computing device 102 are communicatively coupled via a wireless connection.

Process 400 continues by detecting, by the second mobile computing device 102, a first gap in the received live audio stream at step 408. Process 400 finishes by calculating, by the second mobile computing device 102, at least one of a timestamp corresponding to the first gap in the received live audio stream or a duration of the first gap in the received live audio stream at step 410. In some embodiments, the duration of the first gap in the received live audio stream is less than 20 milliseconds. For example, in some embodiments, the duration of the first gap in the received live audio stream is less than 10 milliseconds. In some embodiments, the duration of the first gap in the received live audio stream is less than 5 milliseconds.

In some embodiments, process 400 continues by detecting, by the second mobile computing device 102, a second gap in the received live audio stream. For example, in some embodiments, process 400 continues by calculating, by the second mobile computing device 102, at least one of a timestamp corresponding to the second gap in the received live audio stream or a duration of the second gap in the received live audio stream. In some embodiments, process 400 continues by calculating, by the second mobile computing device 102, a rate of gaps corresponding to the received live audio stream.

Process 400 can be implemented using a system for real-time detection of millisecond gaps in live audio streams. The system includes a first mobile computing device 102 communicatively coupled to a second mobile computing device 102. For example, in some embodiments, the first mobile computing device 102 and the second mobile computing device 102 are communicatively coupled via a wired connection. In other embodiments, the first mobile computing device 102 and the second mobile computing device 102 are communicatively coupled via a wireless connection.

The first mobile computing device 102 is configured to receive a data representation of a live audio signal corresponding to a live event via a wireless network 106. In some embodiments, the system includes an audio server computing device 104 communicatively coupled to the first mobile computing device 102, the first mobile computing device 102 configured to receive the data representation of the live audio signal corresponding to the live event from the audio server computing device 104 via the wireless network 106.

The first mobile computing device 102 is also configured to process the data representation of the live audio signal corresponding to the live event into a live audio stream. The first mobile computing device 102 is also configured to transmit the live audio stream to the second mobile computing device 102 communicatively coupled to the first mobile computing device.

The second mobile computing device 102 is configured to detect a first gap in the received live audio stream. The second mobile computing device 102 is also configured to calculate at least one of a timestamp corresponding to the first gap in the received live audio stream or a duration of the first gap in the received live audio stream. In some embodiments, the duration of the first gap in the received live audio stream is less than 20 milliseconds. For example, in some embodiments, the duration of the first gap in the received live audio stream is less than 10 milliseconds. In some embodiments, the duration of the first gap in the received live audio stream is less than 5 milliseconds.

In some embodiments, the second mobile computing device 102 is also configured to detect a second gap in the received live audio stream. For example, in some embodiments, the second mobile computing device 102 is also configured to calculate at least one of a timestamp corresponding to the second gap in the received live audio stream or a duration of the second gap in the received live audio stream. In some embodiments, the second mobile computing device 102 is also configured to calculate a rate of gaps corresponding to the received live audio stream.

Upon detecting one or more gaps in the received live audio stream and determining the duration and/or rate of the gaps, the second mobile computing device 102 can be configured to transmit a notification message to a remote computing device (such as first mobile computing device 102 and/or server computing device 104). In some embodiments, the notification message can comprise data and/or metadata associated with the detected gaps-such as stream statistics, timestamps, gap durations, gap rates, and other data. The remote computing device can receive the notification message and implement one or more audio transmission corrections to automatically reduce or eliminate gaps in the stream. For example, the remote computing device can increase a buffer size for storing the live audio stream, e.g., to ensure that buffer underruns do not occur or are less likely to occur.

The systems and methods described herein can be implemented using supervised learning and/or machine learning algorithms. Supervised learning is the machine learning task of learning a function that maps an input to an output based on example of input-output pairs. It infers a function from labeled training data consisting of a set of training examples. Each example is a pair consisting of an input object and a desired output value. A supervised learning algorithm or machine learning algorithm analyzes the training data and produces an inferred function, which can be used for mapping new examples.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account-which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™ Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN),), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

While the invention has been particularly shown and described with reference to specific preferred embodiments, it should be understood by those skilled in the art that various changes in form and detail may be made therein without departing from the spirit and scope of the invention as defined by the following claims. One skilled in the art will realize the subject matter may be embodied in other specific forms without departing from the spirit or essential characteristics thereof. The foregoing embodiments are therefore to be considered in all respects illustrative rather than limiting the subject matter described herein.

1. A computerized method for real-time detection of millisecond gaps in live audio streams, the method comprising:
receiving, by a first mobile computing device, a data representation of a live audio signal corresponding to a live event via a wireless network;
processing, by the first mobile computing device, the data representation of the live audio signal corresponding to the live event into a live audio stream;
transmitting, by the first mobile computing device, the live audio stream to a second mobile computing device communicatively coupled to the first mobile computing device;
detecting, by the second mobile computing device, a first gap in the received live audio stream; and
calculating, by the second mobile computing device, at least one of a timestamp corresponding to the first gap in the received live audio stream or a duration of the first gap in the received live audio stream.

2. The computerized method of claim 1, wherein the duration of the first gap in the received live audio stream is less than 20 milliseconds.

3. The computerized method of claim 2, wherein the duration of the first gap in the received live audio stream is less than 10 milliseconds.

4. The computerized method of claim 3, wherein the duration of the first gap in the received live audio stream is less than 5 milliseconds.

5. The computerized method of claim 1, further comprising:
detecting, by the second mobile computing device, a second gap in the received live audio stream.

6. The computerized method of claim 5, further comprising:
calculating, by the second mobile computing device, at least one of a timestamp corresponding to the second gap in the received live audio stream or a duration of the second gap in the received live audio stream.

7. The computerized method of claim 5, further comprising:
calculating, by the second mobile computing device, a rate of gaps corresponding to the received live audio stream.

8. The computerized method of claim 1, wherein the first mobile computing device and the second mobile computing device are communicatively coupled via a wired connection.

9. The computerized method of claim 1, wherein the first mobile computing device and the second mobile computing device are communicatively coupled via a wireless connection.

10. The computerized method of claim 1, further comprising:
receiving, by the first mobile computing device, the data representation of the live audio signal corresponding to the live event from an audio server computing device via the wireless network.

11. A system for real-time detection of millisecond gaps in live audio streams, the system comprising:
a first mobile computing device communicatively coupled to a second mobile computing device, the first mobile computing device configured to:
receive a data representation of a live audio signal corresponding to a live event via a wireless network;
process the data representation of the live audio signal corresponding to the live event into a live audio stream; and
transmit the live audio stream to the second mobile computing device communicatively coupled to the first mobile computing device; and
the second mobile computing device configured to:
detect a first gap in the received live audio stream; and
calculate at least one of a timestamp corresponding to the first gap in the received live audio stream or a duration of the first gap in the received live audio stream.

12. The system of claim 11, wherein the duration of the first gap in the received live audio stream is less than 20 milliseconds.

13. The system of claim 12, wherein the duration of the first gap in the received live audio stream is less than 10 milliseconds.

14. The system of claim 13, wherein the duration of the first gap in the received live audio stream is less than 5 milliseconds.

15. The system of claim 11, wherein the second mobile computing device is further configured to:
detect a second gap in the received live audio stream.

16. The system of claim 15, wherein the second mobile computing device is further configured to:
calculate at least one of a timestamp corresponding to the second gap in the received live audio stream or a duration of the second gap in the received live audio stream.

17. The system of claim 15, wherein the second mobile computing device is further configured to:
calculate a rate of gaps corresponding to the received live audio stream.

18. The system of claim 11, wherein the first mobile computing device and the second mobile computing device are communicatively coupled via a wired connection.

19. The system of claim 11, wherein the first mobile computing device and the second mobile computing device are communicatively coupled via a wireless connection.

20. The system of claim 11, further comprising an audio server computing device communicatively coupled to the first mobile computing device via the wireless network, the first mobile computing device further configured to:
receive the data representation of the live audio signal corresponding to the live event from the audio server computing device via the wireless network.
